(19) United States
(12) Patent Application Publication
(10) Pub. No.: US 2015/0232125 A1
(43) Pub. Date: Aug. 20, 2015

(54) PARKING ASSISTANCE SYSTEM

(71) Applicant: CATERPILLAR INC., PEORIA, IL (US)

(72) Inventors: Bradley S. Kriel, PITTSBURGH, PA (US); MATHEW CHACKO, DUNLAP, IL (US); HONG LIU, PEORIA, IL (US); RICHARD L. HUNZIKER, II, TUCSON, AZ (US); MATTHEW A. CSENCSITS, OAKMONT, PA (US); JAMES M. HANNER, AMADO, AZ (US); PETER R. LAWTON, PITTSBURGH, PA (US)

(73) Assignee: CATERPILLAR INC., PEORIA, IL (US)

(21) Appl. No.: 14/181,760

(22) Filed: Feb. 17, 2014

(51) Int. Cl. B62D 15/02; B60R 1/00; B60K 35/00

(52) U.S. Cl. CPC B62D 15/028; B60K 35/00; B60R 1/00; B60K 2350/1076; B60R 2300/301

(57) ABSTRACT

A system for assisting an operator to maneuver a first machine relative to a second machine on a worksite is provided. The system includes a display device and a controller located onboard the first machine. The display device is configured to display an image feed associated with the first machine. The controller is configured to superimpose on the image feed a first line indicative of an axis associated with the first machine when a reverse gear of the first machine is engaged. The controller is configured to determine an angle of a reference point associated with the second machine and to determine a position of the second machine with respect to the first machine. The controller is configured to superimpose on the image feed a second line indicative of an axis associated with the reference point of the second machine.

### TECHNICAL FIELD

The present disclosure relates to a parking assistance system for a machine, and more specifically to a system and method for assisting an operator in maneuvering the machine on a worksite.

### BACKGROUND

During loading operation of material from a loading machine, such as, a shovel, a conveyor and so on, onto a transportation machine, such as, a truck, the transportation machine needs to be docked in an appropriate loading location with respect to the loading machine, in order to ensure proper loading of the material. Usually, an operator of the loading machine may indicate to an operator of the transportation machine the loading location at which the transportation machine needs to reach by holding an implement of the loading machine over the loading location. The operator of the transportation machine may then visually judge how to maneuver the transportation machine in order to reach the loading location, wherein the loading location is positioned approximately below the implement of the loading machine. Sometimes the operator of the transportation machine may be unable to consistently position the transportation machine at the desired loading location. This may lead to an increased spotting time for the transportation machine and also a long waiting time associated with the loading machine, resulting in an overall low loading efficiency.

Currently used parking assistance systems for transportation machines include one or more rear view cameras to provide a view rearwardly of the transportation machine. Additionally, proximity sensors may also be utilized to indicate the presence of nearby obstacles and/or distance of the transportation machine from the obstacles.

U.S. Published Application Number 2011/0181441 discloses a parking guidance system. The parking guidance system is mounted on a vehicle and includes a camera, a display device with a display correction system, a parking mode selection apparatus, a parking area selection apparatus, a first turning guidance apparatus, and a second turning guidance apparatus. The camera is mounted at rear of the vehicle to capture an image showing environment behind the vehicle. The display device with a display correction system is coupled to the camera and is configured to display an image corrected by the display correction system. The parking mode selection apparatus is coupled to the display device. The parking mode selection apparatus displays a predicted parking area on the display device. The parking area selection apparatus is coupled to the display device. The parking area selection apparatus displays a parking guidance area on the display device. The first turning guidance apparatus is coupled to the display device. The first turning guidance apparatus displays an arc on the display device. The second turning guidance apparatus is coupled to the display device. The second turning guidance apparatus displays on the display device a parking track with distance indication.

### SUMMARY OF THE DISCLOSURE

In one aspect of the present disclosure, a system for assisting an operator to maneuver a first machine relative to a second machine on a worksite is provided. The system includes a display device located onboard the first machine. The display device is configured to display an image feed of any one of a rear view and a bird's eye view associated with the first machine. The system also includes a controller located onboard the first machine. The controller is communicably coupled to the display device. The controller is configured to superimpose on the image feed a first line indicative of an axis associated with the first machine when a reverse gear of the first machine is engaged. The controller is configured to determine an angle of a reference point associated with the second machine with respect to the first machine. The controller is also configured to determine a position of the second machine with respect to the first machine. The controller is further configured to superimpose on the image feed a second line indicative of an axis associated with the reference point of the second machine based on the determined position of the second machine with respect to the first machine.

In another aspect of the present disclosure, a system for assisting an operator to maneuver a first machine relative to a second machine on a worksite is provided. The system includes a display device located onboard the first machine. The display device is configured to display an image feed of any one of a rear view and a bird's eye view associated with the first machine. The system also includes a controller located onboard the first machine. The controller is communicably coupled to the display device. The controller is configured to superimpose on the image feed a first line indicative of an axis associated with the first machine when a reverse gear of the first machine is engaged. The controller is configured to determine an angle of a pin joint associated with an implement of the second machine with respect to the first machine. The controller is also configured to detect if at least a portion of the second machine is present in the image feed. The controller is further configured to superimpose on the image feed a second line indicative of an axis associated with the pin joint of the implement of the second machine based on the detection.

In yet another aspect of the present disclosure, a method for assisting an operator to maneuver a first machine relative to a second machine on a worksite is provided. The method includes displaying an image feed of any one of a rear view and a bird's eye view associated with the first machine. The method includes superimposing on the image feed a first line indicative of an axis associated with the first machine when a reverse gear of the first machine is engaged. The method includes determining an angle of a reference point associated with the second machine with respect to the first machine. The method also includes determining a position of the second machine with respect to the first machine. The method further includes superimposing on the image feed a second line indicative of an axis associated with the reference point of the second machine based on the determined position of the second machine with respect to the first machine.

Other features and aspects of this disclosure will be apparent from the following description and the accompanying drawings.

### BRIEF DESCRIPTION OF THE DRAWINGS

FIG. 1 is a schematic view of an exemplary environment including a worksite and different machines employed thereon, according to an embodiment of the present disclosure;

FIG. 2 is a schematic overhead view of the worksite showing a first machine, a second machine and a loading location;

FIG. 3 is a block diagram of an exemplary parking assistance system;

FIGS. 4-6 are a set of exemplary displays provided by the parking assistance system;

FIGS. 7-9 are another set of exemplary displays provided by the parking assistance system; and

FIG. 10 is a flowchart of a method of operation of the parking assistance system.

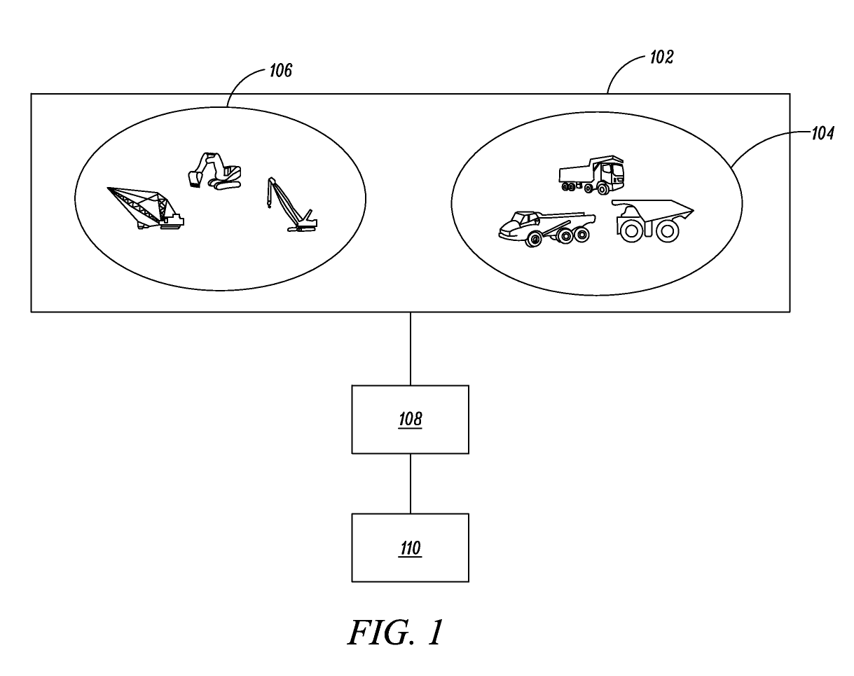

### DETAILED DESCRIPTION

Wherever possible the same reference numbers will be used throughout the drawings to refer to the same or the like parts. FIG. 1 illustrates an exemplary worksite 102. A number of different first machines 104 configured for transportation of material from one location to another may be deployed on the worksite 102. The first machine 104 may be for example, a mining truck, a haul truck, an on-highway truck, an off-highway truck, an articulated truck, and so on. Further, a number of different second machines 106 may also be deployed on the worksite 102. The second machine 106 is configured to load the material on the first machine 104. The second machines 106 may include, for example, a conveyor, a large wheel loader, a track-type loader, a shovel, a dragline, a crane or any other machine known to one skilled in the art.

In an embodiment, the first machine 104 and the second machine 106 may be communicably coupled to each other via a communication system 108. In another embodiment, the first machine 104 and the second machine 106 may be communicably coupled to a remote control station 110 via the communication system 108. Typically, the remote control station 110 is located away from the worksite 102. The remote control station 110 may enable remote monitoring and/or controlling of various functions related to operation of the second machine 106 and/or the first machine 104 deployed on the worksite 102.

The communication system 108 may include, but not limited to, a wide area network (WAN), a local area network (LAN), an Ethernet, Internet, an Intranet, a cellular network, a satellite network, or any other suitable network for transmitting data between the first machine 104, the second machine 106 and/or the remote control station 110. In various embodiments, the communication system 108 may include a combination of two or more of the aforementioned networks and/or other types of networks known in the art. The communication system 108 may be implemented as a wired network, a wireless network or a combination thereof. Further, data transmission between the first machine 104, the second machine 106 and/or the remote control station 110 may occur over the communication system 108 in an encrypted or otherwise secure format, in any of a wide variety of known manners.

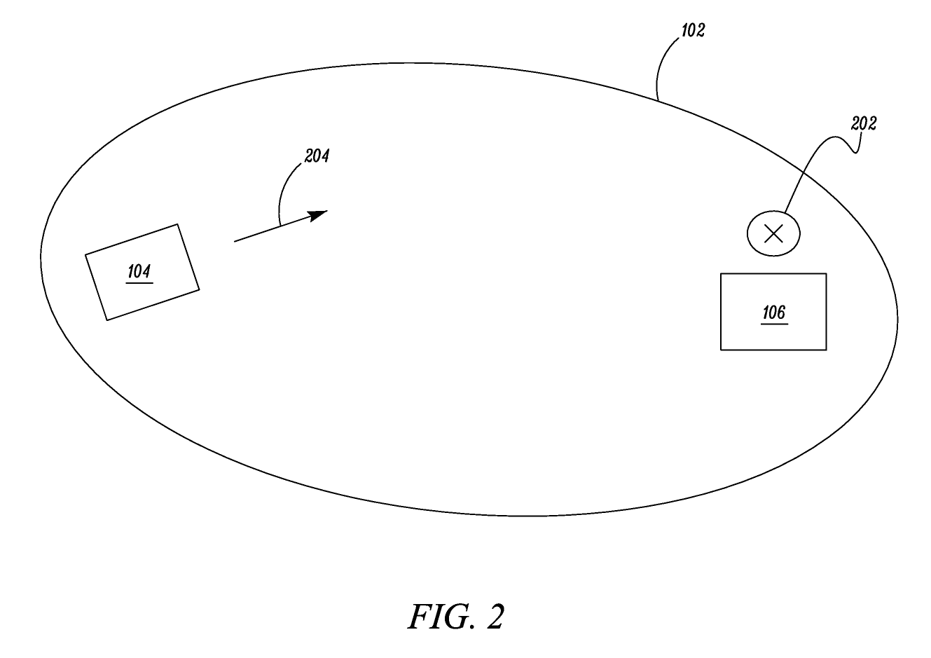

FIG. 2 illustrates a schematic overhead view of a portion of the worksite 102 having the second machine 106 and the first machine 104. The first and second machines 104, 106 are capable of movement on the worksite 102. An arrow 204 in FIG. 2 indicates a direction of movement of the first machine 104 on the worksite 102. Once the second machine 106 is parked or docked at a given location on the worksite 102, one or more loading locations may be associated with the second machine 106. In the exemplary situation shown in FIG. 2, a loading location 202 is provided on the worksite 102 adjacent to the second machine 106. It should be noted that the location of the loading location 202 with respect to the second machine 106 shown in the accompanying figures is exemplary and does not limit the scope of the present disclosure. The loading location 202 is indicative of the position at which the first machine 104 needs to be docked or parked in order for the second machine 106 to load the material onto the first machine 104.

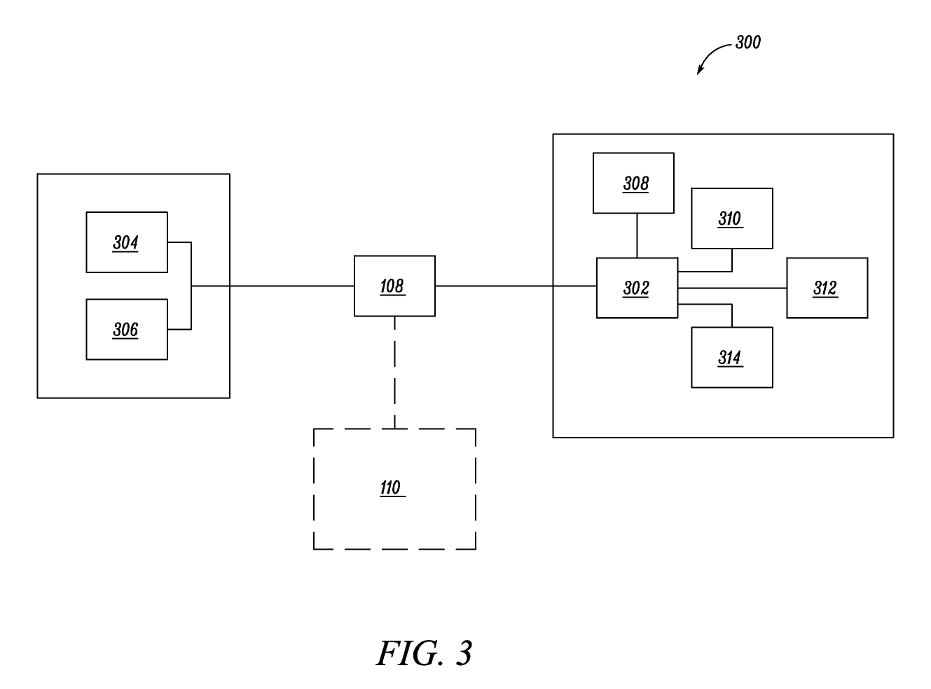

Typically, the loading location 202 may be provided proximate to the second machine 106 based on possible positions of a linkage assembly (not shown) of the second machine 106. More specifically, since the linkage assembly is capable of movement in an arcuate manner with different lengths of extension of a lift arm (not shown), the loading location 202 may be positioned at different distances on either side of the second machine 106. FIG. 3 illustrates a block diagram of a parking assistance system 300. The parking assistance system 300 is configured to assist an operator of the first machine 104 to maneuver the first machine 104 relative to the second machine 106 on the worksite 102. More specifically, the parking assistance system 300 is configured to assist in parking of the first machine 104 in the loading location 202. The parking assistance system 300 includes a controller 302 located onboard the first machine 104, the working of which will be explained in detail in subsequent paragraphs.

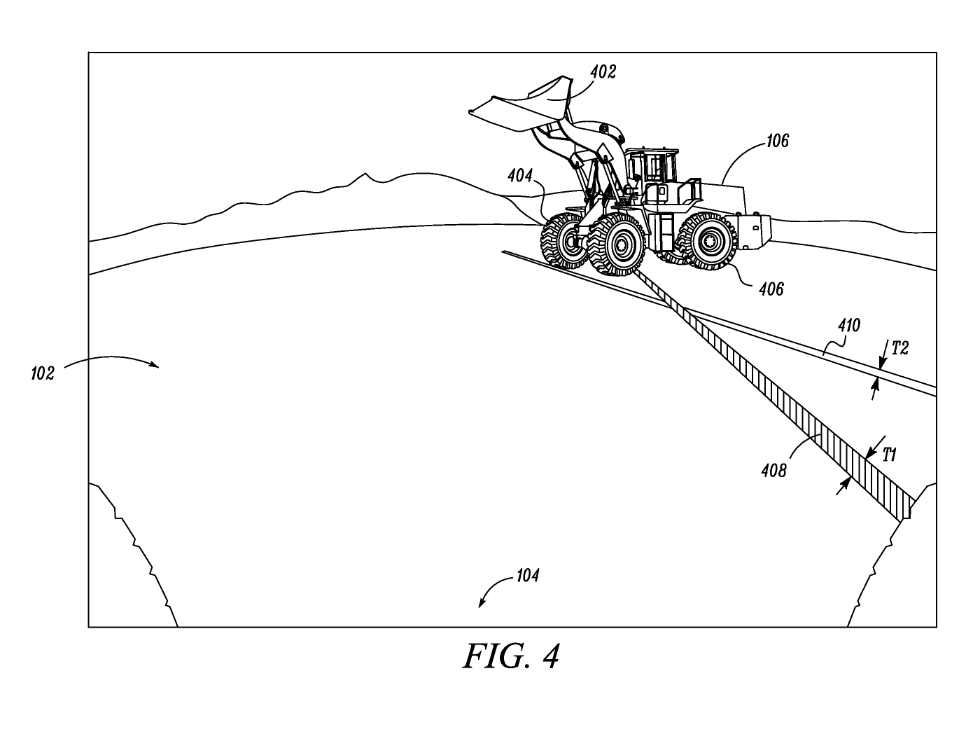

A sensor 304 is located onboard the second machine 106. The sensor 304 is communicably coupled to the controller 302. The sensor 304 is configured to generate a signal indicative of an angle and/or a position of a reference point associated with the second machine 106 with respect to the first machine 104. More specifically, the sensor 304 is configured to generate a signal indicative of a position of an implement 402 (shown in FIG. 4) such as, a bucket associated with the second machine 106. In an embodiment, the reference point may include a pin joint (not shown) associated with the implement 402 of the second machine 106. The pin joint may be a pivot point about which the implement 402 is mounted on the second machine 106. In another embodiment, the reference point may be an edge or an axis of the implement 402. In yet another embodiment, the reference point may be an edge or an axis of the second machine 106. In further embodiments, the reference point may be an axle, such as a front axle or a rear axle, of the second machine 106. Alternatively, the reference point may include one or more wheels, such as a front wheel 404 or a rear wheel 406, of the second machine 106. The sensor 304 may be any sensor known in the art including, but not limited to, an implement position sensor, a proximity sensor and an infrared sensor.

The parking assistance system 300 includes a position detection module 306 located onboard the second machine 106. The position detection module 306 is communicably coupled to the controller 302. The position detection module 306 is configured to generate a signal indicative of a position, for example, location coordinates of the second machine 106 on the worksite 102. The position detection module 306 may be any one or a combination of a Global Positioning System, a Global Navigation Satellite System, a Pseudolite/Pseudo-Satellite, any other Satellite Navigation System, an Inertial Navigation System or any other known position detection module known in the art.

In another embodiment, the second machine 106 may include an Electronic Control Module (ECM) (not shown). The ECM may be configured to control numerous functions of the second machine 106. In such a situation, the ECM may be communicably coupled to the sensor 304 and the position detection module 306. The ECM may be configured to receive the signals from the sensor 304 and the position detection module 306. The ECM may be further communicably coupled to the controller 302 located onboard the first machine 104. In this embodiment, the controller 302 may be configured to receive the signals generated by the sensor 304 and the position detection module 306 from the ECM.

In another embodiment, the remote control station 110 may include an additional controller (not shown) communicably coupled to the sensor 304 and the position detection module 306 located onboard the second machine 106. The additional controller is configured to receive the signals from the sensor 304 and the position detection module 306. The additional controller may be further communicably coupled to the controller 302 located onboard the first machine 104. In this embodiment, the controller 302 may be configured to receive the signals generated by the sensor 304 and the position detection module 306 from the additional controller.

The parking assistance system 300 includes a position determination module 308 located onboard the first machine 104. The position determination module 308 is communicably coupled to the controller 302. The position determination module 308 is configured to generate a signal indicative of a position such as location coordinates of the first machine 104 on the worksite 102. The position determination module 308 may be any one or a combination of a Global Positioning System, a Global Navigation Satellite System, a Pseudolite/Pseudo-Satellite, any other Satellite Navigation System, an Inertial Navigation System or any other known position determination module known in the art.

The parking assistance system 300 may include a gear position sensor 310 located onboard the first machine 104. The gear position sensor 310 is communicably coupled to the controller 302. The gear position sensor 310 is configured to generate a signal indicative of a status of engagement of the gear of the first machine 104. More specifically, the gear position sensor 310 is configured to generate a signal indicative of engagement of a reverse gear of the first machine 104.

The parking assistance system 300 includes an image capturing device 312 located onboard the first machine 104. The image capturing device 312 is communicably coupled to the controller 302. The image capturing device 312 may include a CCD camera, a CMOS camera, a night vision camera or any other image capturing and/or image processing device known in the art. The image capturing device 312 is configured to provide a rear view associated with the first machine 104 based on the engagement of the reverse gear of the first machine 104, to the controller 302.

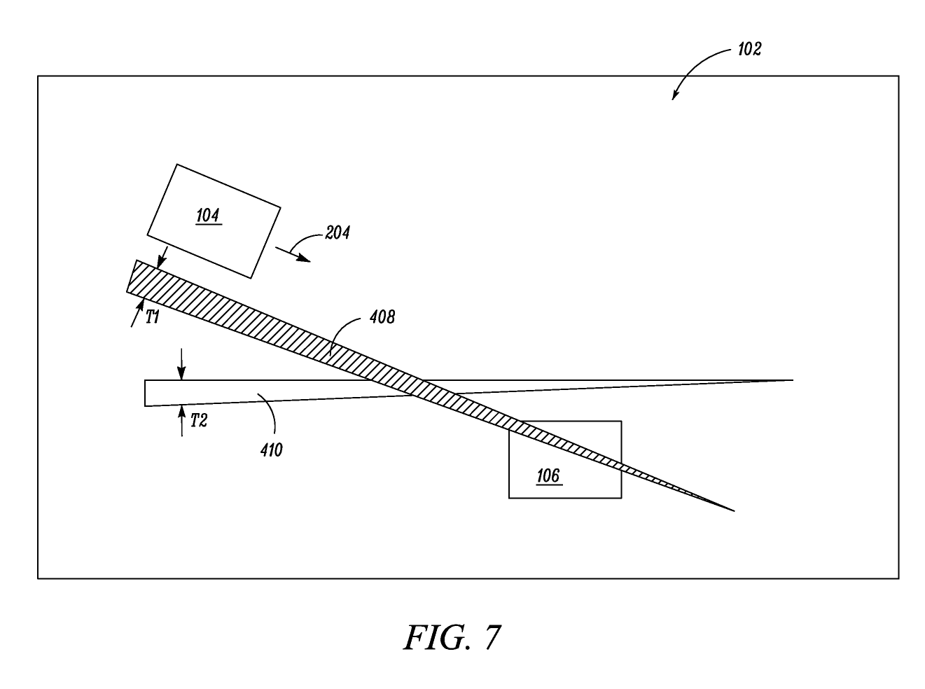

The parking assistance system 300 includes a display device 314 located onboard the first machine 104. The display device 314 is communicably coupled to the controller 302. The display device 314 is configured to display an image feed of the rear view associated with the first machine 104. In another embodiment, the display device 314 may be configured to display the image feed of a bird's eye view of the worksite 102 showing the first machine 104 and the second machine 106 which will be explained later with reference to FIGS. 7-9. The display device 314 may be an LCD device, an LED device, a CRT monitor, a touchscreen device or any other display device known in the art.

Referring to FIG. 4, based on the signals received from the gear position sensor 310 and the image capturing device 312 the controller 302 is configured to display the image feed of the rear view associated with the first machine 104 on the display device 314. The controller 302 is also configured to superimpose on the image feed a first line 408 indicative of an axis associated with the first machine 104 when the reverse gear of the first machine 104 is engaged. More specifically, the first line 408 is superimposed on ground of the image feed. In an embodiment, the axis of the first machine 104 includes the axis associated with a side of the first machine 104, such as, an operator side of the first machine 104. In other embodiments, the axis of the first machine 104 may include the axis associated with a center of the first machine 104, for example, a longitudinal axis of the first machine 104.

Based on the signal received from the sensor 304 located on the second machine 106, the controller 302 is configured to determine the angle and/or the position on the worksite 102, of the reference point associated with the second machine 106. Further, the controller 302 is configured to determine the position of the second machine 106 with respect to the first machine 104. The position of the second machine 106 with respect to the first machine 104 may be determined in various ways.

In an embodiment, the controller 302 may be configured to determine the position of the second machine 106 with respect to the first machine 104 based on the location coordinates received from the position detection module 306 and the position determination module 308 of the second machine 106 and the first machine 104 respectively by any known position determination method known in the art. In a situation when the worksite 102 may include a plurality of the second machines 106, the controller 302 may be configured to determine the position of the second machine 106 which is nearest to the first machine 104.

In another embodiment, an object detection system (not shown) may be employed within the parking assistance system 300. The object detection system may detect at least a portion of the second machine 106 on the image feed displayed on the display device 314. In a situation when the worksite 102 may include the plurality of the second machines 106, the object detection system may be configured to detect the second machine 106 nearest to the first machine 104. Further, based on the location coordinates received from the position detection module 306 and the position determination module 308 of the second machine 106 and the first machine 104 respectively, the controller 302 may be configured to determine the position of the second machine 106 with respect to the first machine 104.

Based on the determined position of the second machine 106 with respect to the first machine 104, the controller 302 is configured to superimpose on the image feed a second line 410 indicative of the axis associated with the reference point of the second machine 106. More specifically, the second line 410 is superimposed on the ground of the image feed. In an embodiment, the controller 302 may be configured to superimpose the second line 410 on the image feed if the second machine 106 is present in the image feed associated with the first machine 104. In such a situation, the controller 302 may superimpose the second line 410 on the image feed when the object detection system may detect the presence of the second machine 106 on the image feed displayed on the display device 314.

In other embodiment, the controller 302 may be configured to superimpose the second line 410 on the image feed if the location coordinates of the second machine 106 are indicative of the presence of the second machine 106 within a predefined distance from the first machine 104. In an embodiment, the predefined distance may include a predetermined distance between the second machine 106 and the first machine 104. In other embodiment, the predefined distance may be a predetermined distance between the first machine 104 and a fixed boundary or zone defined on the worksite 102. This boundary may define a virtual work area on the worksite 102. As shown in the accompanying figures, the first line 408 and the second line 410 displayed on the image feed may have a tapering thickness T1 and T2 respectively based on the determined position of the second machine 106 with respect of the first machine 104. The tapering thickness T1, T2 of the first line 408 and/or the second line 410 respectively may change based on the determined position of the second machine 106 with respect of the first machine 104. For example, as the first machine 104 moves closer to the second machine 106, the tapering thickness T1, T2 of the first line 408 and/or the second line 410 respectively may reduce. Further, as the first machine 104 may move away from the second machine 106, the tapering thickness T1, T2 of the first line 408 and/or the second line 410 may increase or vice versa.

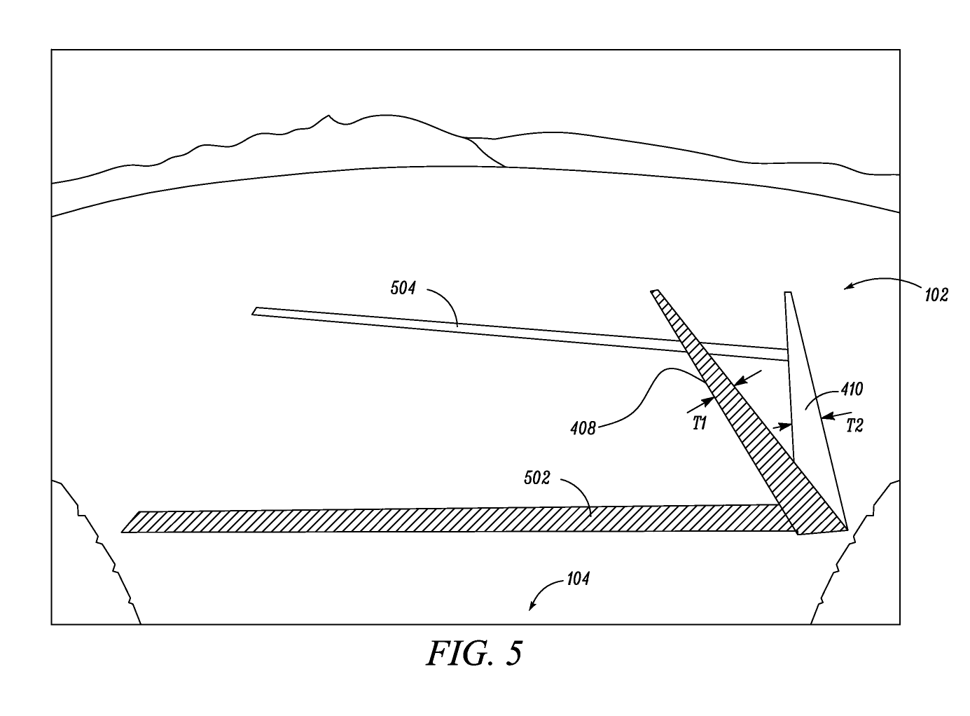

Based on the position of the second machine 106 with respect to the first machine 104, as shown in FIG. 5, the controller 302 is configured to superimpose on the image feed a third line 502 perpendicular to the first line 408. Also, the controller 302 is also configured to superimpose on the image feed a fourth line 504 perpendicular to the second line 410. More specifically, the third line 502 and the fourth line 504 are superimposed on the image feed based on the distance between the second machine 106 and the first machine 104. The third line 502 may be indicative of a rear edge of the first machine 104. The fourth line 504 may be indicative of a docking limit associated with the second machine 106. The docking limit is indicative of a reversing limit associated with the loading location 202 up to which the first machine 104 requires to be backed up for positioning the first machine 104 at the loading location 202.

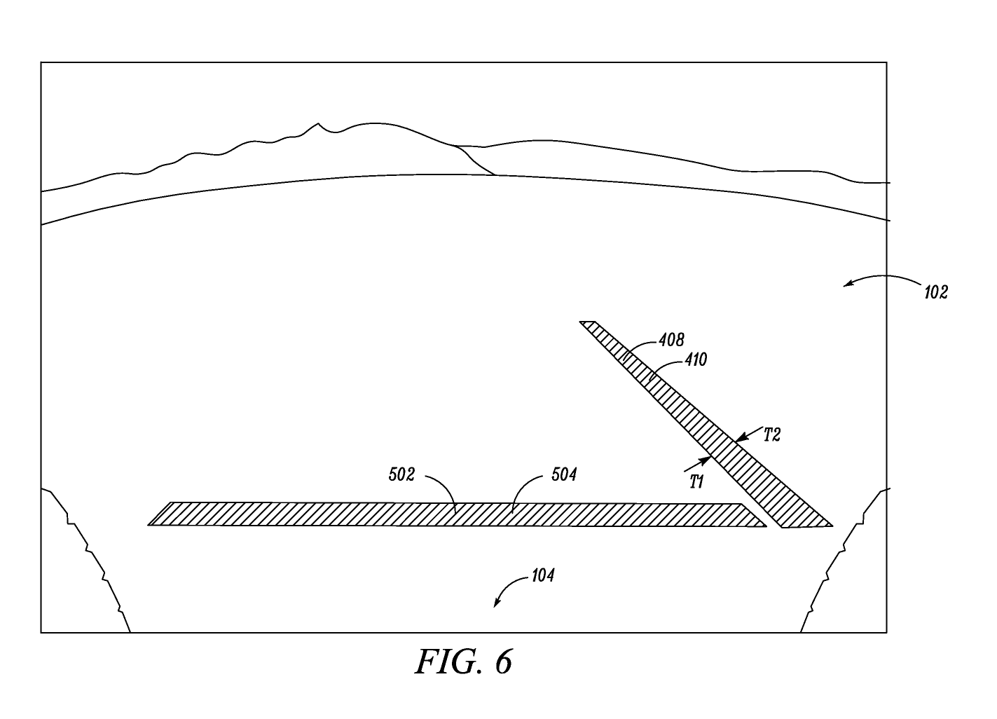

Further, as shown in FIG. 6, as the first machine 104 may back up to the loading location 202, the overlap of the first line 408 and the third line 502 on the second line 410 and the fourth line 504 respectively may indicate to the operator of the first machine 104 that the first machine 104 is docked as required. The controller 302 is configured to change an appearance of at least one of the first line 408, the second line 410, the third line 502 and/or the fourth line 504 based on the determined position of the second machine 106 with respect to the first machine 104. Additionally or optionally, the controller 302 is configured to change an appearance of at least one of the first line 408, the second line 410, the third line 502 and/or the fourth line 504 based on an alignment of the first line 408 and/or the third line 502 with respect to the second line 410 and/or the fourth line 504 respectively, on the image feed. For example, based on the determined position of the first machine 104 with respect to the second machine 106, parameters including, but not limited to, a color, a line font, a brightness, a transparency level and a dimension of the first line 408, the second line 410, the third line 502 and/or the fourth line 504 may change.

In one embodiment, the parking assistance system 300 may include an external image capturing device (not shown) located on the worksite 102. The external image capturing device may be communicably coupled to the controller 302. The external image capturing device may include a CCD camera, a CMOS camera, a night vision camera or any other image capturing and/or image processing devices known in the art. The external image capturing device may be configured to provide the bird's eye view of the worksite 102 associated with the first machine 104 to the controller 302, based on the engagement of the reverse gear of the first machine 104.

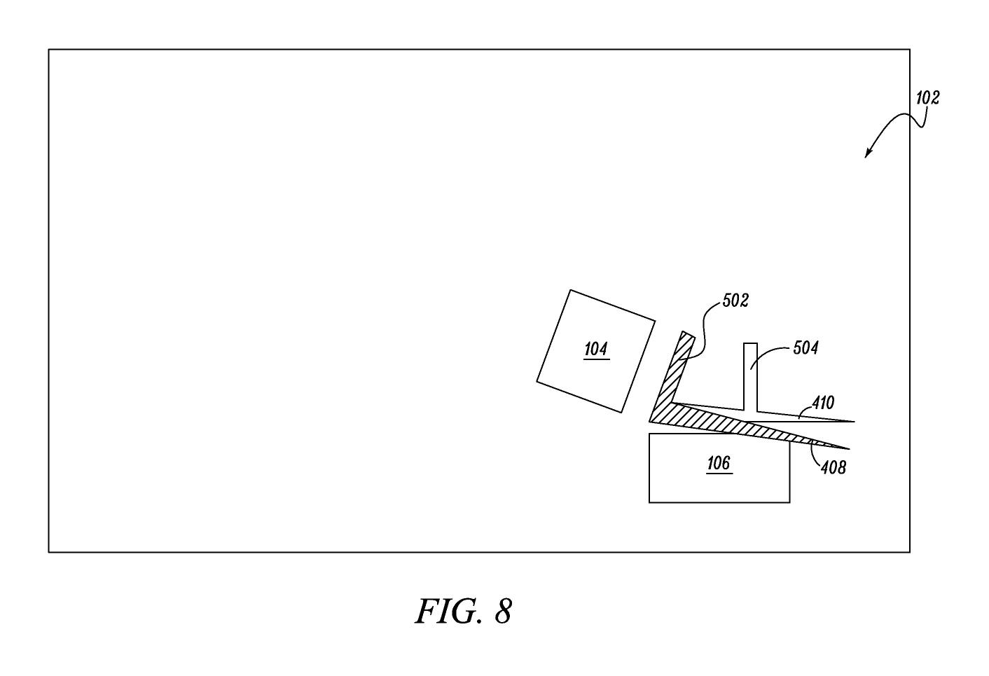

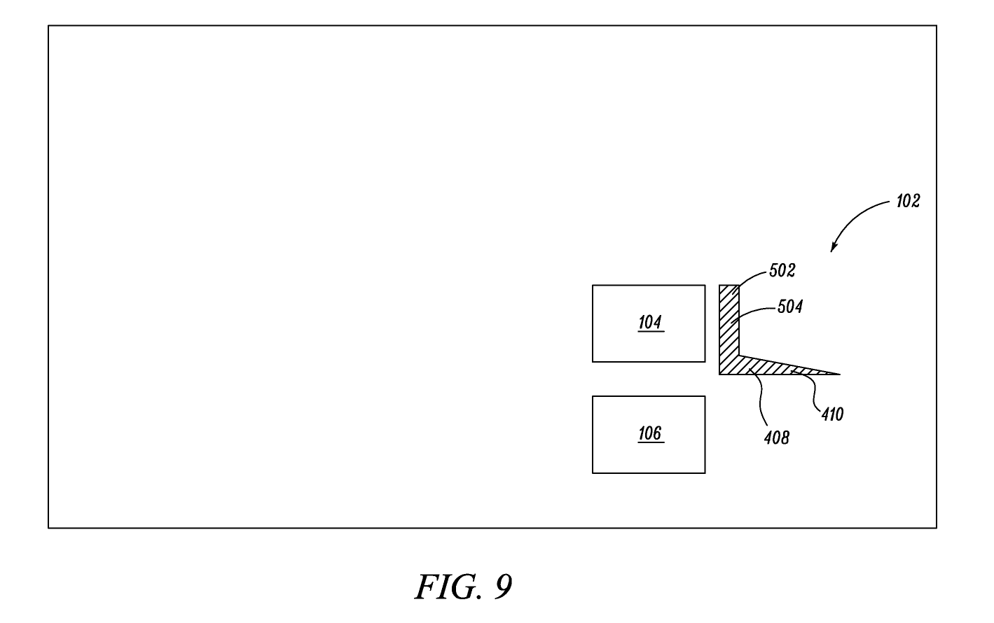

As shown in FIGS. 7-9, the controller 302 may display the bird's eye view of the worksite 102 showing the first machine 104 and the second machine 106 on the display device 314. FIGS. 7-9 correspond to FIGS. 4-6 respectively and show corresponding bird's eye view with respect to the rear view associated with the first machine 104 shown in FIGS. 4-6. For example, FIG. 7 illustrates the bird's eye view showing the first machine 104, the second machine 106, the first line 408 and the second line 410 as illustrated in the rear view associated with the first machine 104 shown in FIG. 4. FIG. 8 illustrates the bird's eye view showing the first machine 104, the second machine 106, the first line 408, the second line 410, the third line 502 and the fourth line 504 as illustrated in the rear view associated with the first machine 104 shown in FIG. 5. FIG. 9 illustrates the bird's eye view showing the first machine 104, the second machine 106 and, the first line 408 and the third line 502 overlapping with the second line 410 and the fourth line 504 respectively as illustrated in the rear view associated with the first machine 104 shown in FIG. 6.

In another embodiment, the controller 302 may be configured to switch between the rear view and the bird's eye view based on the determined position of the first machine 104 with respect to the second machine 106. In such a situation, the controller 302 may be configured to monitor the position of the first machine 104. The controller 302 may then determine when the position of the first machine 104 crosses the predefined distance. When such an event may occur, the controller 302 may be configured to switch the image feed displayed on the display device 314 from the rear view to the bird's eye view or vice versa based on the determined position of the second machine 106 with respect to the first machine 104.

For example, when the position of the first machine 104 may be equal to or lesser than the predefined distance of say, for example, 30 m from the second machine 106, the display on the display device 314 may switch or change from the rear view to the bird's eye view, or vice versa. Further, when the position of the first machine 104 may be greater than the predefined distance of approximately 30 m, the display on the display device 314 may switch or change from the bird's eye view to the rear view, or vice versa.

The controller 302, the ECM and/or the additional controller may embody a single microprocessor or multiple microprocessors that includes a means for receiving signals from the components of the parking assistance system 300. Numerous commercially available microprocessors may be configured to perform the functions of the controller 302, the ECM and/or the additional controller. It should be appreciated that the controller 302, the ECM and/or the additional controller may readily embody a general machine microprocessor capable of controlling numerous machine functions. A person of ordinary skill in the art will appreciate that the controller 302, the ECM and/or the additional controller may additionally include other components and may also perform other functionality not described herein. It should be understood that the embodiments and the configurations and connections explained herein are merely on an exemplary basis and may not limit the scope and spirit of the disclosure.

### INDUSTRIAL APPLICABILITY

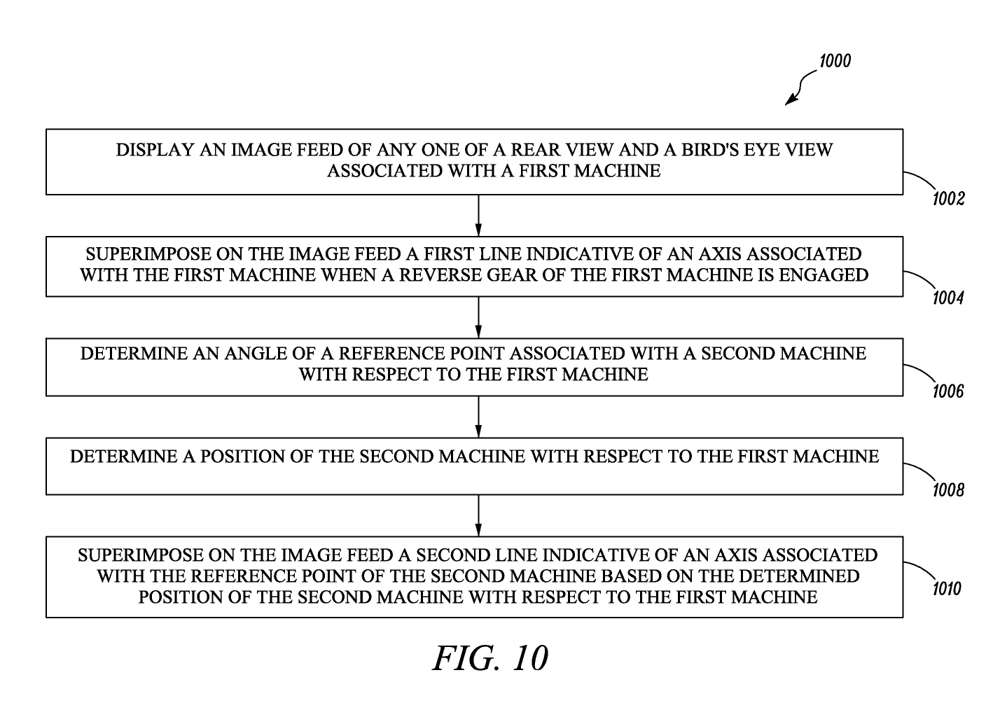

The present disclosure relates to a system and method for assisting the operator to maneuver the first machine 104 relative to the second machine 106 on the worksite 102. Referring to FIG. 10, a flowchart of a method 1000 is illustrated. At step 1002, the controller 302 displays the image feed of any one of the rear view and the bird's eye view associated with the first machine 104 based on the determined position of the first machine 104 with respect to the second machine 106.

In a situation when the parking assistance system 300 includes the image capturing device 312 located onboard the first machine 104, the image feed of the rear view associated with the first machine 104 is displayed on the display device 314. In a situation when the parking assistance system 300 includes the external image capturing device located on the worksite 102, the image feed of the bird's eye view associated with the first machine 104 and the second machine 106 is displayed on the display device 314. In a situation when the parking assistance system 300 includes the image capturing device 312 located onboard the first machine 104 and the external image capturing device located on the worksite 102, the controller 302 switches between the image feed of the rear view and the bird's eye view respectively to be displayed on the display device 314, based on the determined position of the first machine 104 with respect to the second machine 106.

At step 1004, the controller 302 superimposes on the image feed the first line 408 indicative of the axis associated with the first machine 104 when the reverse gear of the first machine 104 is engaged. The image feed includes any one of the rear view and the bird's eye view associated with the first machine 104. In an embodiment, the controller 302 superimposes on the image feed the first line 408 indicative of the axis associated with the first machine 104 when the reverse gear of the first machine 104 is engaged and when the object detection system detects at least the portion of the second machine 106 on the image feed. In another embodiment, the controller 302 superimposes on the image feed the first line 408 indicative of the axis associated with the first machine 104 when the reverse gear of the first machine 104 is engaged and when the second machine 106 is within the predefined distance from the first machine 104.

At step 1006, the controller 302 determines the angle and/or the position, on the worksite 102, of the reference point associated with the second machine 106 with respect to the first machine 104. The controller 302 determines the angle and/or the position of the reference point based on the signal received from the sensor 304 located on the second machine 106. At step 1008, the controller 302 determines the position of the second machine 106 with respect to the first machine 104 based on the signals received from the position detection module 306 and the position determination module 308 respectively.

At step 1010, the controller 302 superimposes on the image feed the second line 410 indicative of the axis associated with the reference point of the second machine 106 based on the determined position of the second machine 106 with respect to the first machine 104. In an embodiment, the controller 302 may superimpose the second line 410 based on the detection of the second machine 106 on the image feed by the object detection system. In another embodiment, the controller 302 may superimpose the second line 410 based on the predefined distance of the first machine 104 with respect to the second machine 106.

Further, based on the predefined distance of the first machine 104 with respect to the second machine 106, the controller 302 superimposes on the image feed the third line 502 perpendicular to the first line 408. Additionally, based on the predefined distance of the first machine 104 with respect to the second machine 106, the controller 302 superimposes on the image feed the fourth line 504 perpendicular to the second line 410. When the first machine 104 may back up on the loading location 202 in the required orientation, the first line 408 and the third line 502 overlaps on the second line 410 and the fourth line 504 respectively.

The controller 302 changes the appearance of at least one of the first line 408, the second line 410, the third line 502 and/or the fourth line 504 based on the determined position of the second machine 106 with respect to the first machine 104. Additionally or optionally, the controller 302 changes the appearance of at least one of the first line 408, the second line 410, the third line 502 and/or the fourth line 504 based on the alignment of the first line 408 and/or the third line 502 with respect to the second line 410 and/or the fourth line 504 respectively, on the image feed. For example, based on the determined position of the first machine 104 with respect to the second machine 106, parameters including, but not limited to, the color, the line font, the brightness, the transparency level and the dimension of the first line 408, the second line 410, the third line 502 and/or the fourth line 504 may change.

In one embodiment, the controller 302 switches between the rear view and the bird's eye view based on the determined position of the first machine 104 with respect to the second machine 106. In such a situation, the controller 302 monitors the position of the first machine 104. The controller 302 then determines when the position of the first machine 104 crosses the predefined distance. When such an event occurs, the controller 302 switches the image feed displayed on the display device 314 from the rear view to the bird's eye view or vice versa based on the determined position of the second machine 106 with respect to the first machine 104.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for assisting an operator to maneuver a first machine relative to a second machine on a worksite, the system comprising:
a display device located onboard the first machine, the display device configured to display an image feed of any one of a rear view and a bird's eye view associated with the first machine; and
a controller located onboard the first machine, the controller communicably coupled to the display device, the controller configured to:
superimpose on the image feed a first line indicative of an axis associated with the first machine when a reverse gear of the first machine is engaged;
determine an angle of a reference point associated with the second machine with respect to the first machine;
determine a position of the second machine with respect to the first machine; and
superimpose on the image feed a second line indicative of an axis associated with the reference point of the second machine based on the determined position of the second machine with respect to the first machine.

2. The system of claim 1, wherein the position of the second machine with respect to the first machine is determined based on at least one of:
the image feed associated with the first machine; and
location coordinates of the second machine received from a position detection module.

3. The system of claim 2, wherein the controller is configured to superimpose the second line on the image feed if the second machine is present in the image feed associated with the first machine.

4. The system of claim 2, wherein the controller is configured to superimpose the second line on the image feed if the location coordinates of the second machine are indicative of a presence of the second machine within a predefined distance from the first machine.

5. The system of claim 1, wherein the reference point includes any one of a pin joint associated with an implement, an edge of the implement, an axle and a wheel of the second machine.

6. The system of claim 1, wherein the axis of the first machine includes the axis associated with any one of a side of the first machine and a center of the machine.

7. The system of claim 1, wherein the first line displayed on the image feed has a tapering thickness based on the determined position of the second machine with respect to the first machine.

8. The system of claim 1, wherein the superimposition of the first line and the second line is activated based on the determined position of the second machine with respect to the first machine.

9. The system of claim 1, wherein the controller is further configured to:
switch the image feed viewable on the display device between the rear view and the bird's eye view based on the determined position of the second machine with respect to the first machine.

10. The system of claim 1, wherein the controller is further configured to change an appearance of at least one of the first line and the second line based on at least one of:
the determined position of the second machine with respect to the first machine; and
an alignment of the first line with respect to the second line on the image feed.

11. The system of claim 10, wherein the appearance includes at least one of a color, a line style, and a brightness of at least one of the first line and the second line.

12. The system of claim 1, wherein when the second machine is at a predefined distance from the first machine, the controller is further configured to:
superimpose on the image feed a third line perpendicular to the first line; and
superimpose on the image feed a fourth line perpendicular to the second line.

13. A system for assisting an operator to maneuver a first machine relative to a second machine on a worksite, the system comprising:
a display device located onboard the first machine, the display device configured to display an image feed of any one of a rear view and a bird's eye view associated with the first machine; and
a controller located onboard the first machine, the controller communicably coupled to the display device, the controller configured to:
superimpose on the image feed a first line indicative of an axis associated with the first machine when a reverse gear of the first machine is engaged;
determine an angle of a pin joint associated with an implement of the second machine with respect to the first machine;
detect if at least a portion of the second machine is present in the image feed; and
superimpose on the image feed a second line indicative of an axis associated with the pin joint of the implement of the second machine based on the detection.

14. The system of claim 13, wherein the axis of the first machine includes the axis associated with any one of a side of the first machine and a center of the machine.

15. The system of claim 13, wherein the first line displayed on the image feed has a tapering thickness based on a position of the second machine with respect to the first machine.

16. The system of claim 13, wherein the superimposition of the first line and the second line is activated based on a position of the second machine with respect to the first machine.

17. The system of claim 13, wherein the controller is further configured to:
switch the image feed viewable on the display device between the rear view and the bird's eye view based on a position of the second machine with respect to the first machine.

18. The system of claim 13, wherein the controller is further configured to change an appearance of at least one of the first line and the second line based on at least one of:
a position of the second machine with respect to the first machine; and
an alignment of the first line with respect to the second line on the image feed.

19. The system of claim 13, wherein when the second machine is at a predefined distance from the first machine, the controller is further configured to:
superimpose on the image feed a third line perpendicular to the first line; and
superimpose on the image feed a fourth line perpendicular to the second line.

20. A method for assisting an operator to maneuver a first machine relative to a second machine on a worksite, the method comprising:
displaying an image feed of any one of a rear view and a bird's eye view associated with the first machine;
superimposing on the image feed a first line indicative of an axis associated with the first machine when a reverse gear of the first machine is engaged;
determining an angle of a reference point associated with the second machine with respect to the first machine;
determining a position of the second machine with respect to the first machine; and
superimposing on the image feed a second line indicative of an axis associated with the reference point of the second machine based on the determined position of the second machine with respect to the first machine.
